(19) United States
(12) Patent Application Publication
(10) Pub. No.: US 2009/0320316 A1
(43) Pub. Date: Dec. 31, 2009

(54) Portable multipurpose hybrid device which emits ultra violet radiation

(76) Inventor: Tal Zakai, Kiryat Hayim (IL)

Correspondence Address: Tal Zakai, Shivtay Israel 26A, Kiryat Hayim, 26275, IL

(21) Appl. No.: 12/215,480

(22) Filed: Jun. 30, 2008

(51) Int. Cl. F26B 3/347

(52) U.S. Cl. 34/275

(57) ABSTRACT

The present invention related to a portable multipurpose hybrid device which emits ultra violet radiation. Even more specifically, this invention relates to portable multipurpose hybrid device which emits ultra violet radiation, design at unique form. It will be an extended shape device. One side comprising a novel hole with internal screw-on threads in addition to recess at the bottom, which designed to absorb, comprise and reinforce replaceable designation accessories therein such as the base of extruded brush as the same pattern of fingernail polish brush, and to become suitable to perform as cap/cork/cover for cosmetics and health containers, by screwing it on the screw thread neck of the bottle, in order to replace the original cap, in addition to its designation as UV fingernail dryer, with an inner nail brush that dips in the container in order to fulfill its designation to remove liquid material from the container in order to spread it on fingernail or any other object. Disassemble the finger nail brush and assemble instead fishing hook by screwing it to the novel hole and the portable multipurpose hybrid UV device will transfer immediately to attracting fish device. The portable UV device performs as a platform for different usages. The versatility of the portable UV device becomes possible by the assistance of the novel hole. The other side of the portable multipurpose hybrid device which emits ultra violet radiation comprising operating system which includes electric power source, light source, electronics circuit board, and operating switch. Therefore the unique design and its capabilities are disclosed.

### BACKGROUND OF THE INVENTION

Ultra violet devices used in various applications. Cosmetic facilities such as beauty saloon and sun tanning institutes make use with UV devices in order to create artificial sun tanning and finger nail art such finger nail dryer. UV testing devices verifying counterfeit paper money. UV decorative illumination creates nice atmosphere at discotheques and clubs. UV devices breaking up the NOx gas in order to disinfections and purification the air. UV devices use to disinfect products and goods surface, operation and sickness rooms by killing germs and bacterium. UV devices uses to disinfecting pure drinking water, normal water, wastewater, aquaculture water, and medical water, etc. UV devices use to attracting fishes and insects. Devices which emits ultra violet radiation (UV) has two levels of radiation, ionizing and non-ionizing, which are separated by the length of waves they emit. Non-ionizing radiation ranges from 40-400 nanometers and is the most common form of UV radiation being used in biomedical and microbiological research laboratories. The ranges of non-ionizing UV can be charted into three regions: UVA (black light) at 315-400 wavelength (nm), UVB (erythemal) at 280-315 wavelength (nm), UVC (germicidal) at 100-280 wavelength (nm). Ultra violet radiation finger nail dryers are well known in the art. A large variety of such ultra violet dryers are currently commercialized and sold. There are women that go to beauty saloon in order to build, shape and paint their finger nails. Professional beauty saloons make use with ultra violet radiation finger nail dryers in order to dry the nail polish. Despite the comfort by the usage with the accessories and professional aids that the beauty saloon provides, many women treat themselves at home and even on their way to work, at work, at coffee shops and discotheques. Those women carry in their belongings small beauty accessories, such as mirror, nail file, comb, tweezers, cosmetics tubes and cases which containing nail polish, lipstick, mascara, eyeliner, lipliner, and other health and beauty aids. Those women don't carry in their belongings cumbersome equipment such as ultra violet dryers, the same as you can find at the beauty saloon. It is an object of the present invention to provide a novel series of new ultra violet radiation finger nail dryers, which will be easy to carry and use due to its unique design and compact size, that allows to assemble it on cosmetics containers such as finger nail polish containers, in order to function as portable multipurpose hybrid UV nail dryer device which suitable to perform as cap/cork/cover for cosmetics and health containers by replacing the original cap, in addition to its designation as UV fingernail dryer, by screwing it to the screw thread neck of the cosmetic bottle. This way it becomes an integral part from the cosmetics and health containers. The present invention provides an elegant easy to carry cosmetics apparatus solution to the hurry and busy women that would like to file, paint and dry their fingernails on the way to their destination.

### SUMMARY OF THE INVENTION

It is an object of the present invention to provide novel portable multipurpose hybrid device which emits ultra violet radiation as health and beauty aids, providing an elegant solution to the hurry and busy women that would like to file, paint and dry their fingernails on the way to their destination. The portable UV device will be suitable in different versions to every men and women in the society.

It is a further object of the present invention to provide portable multipurpose hybrid device which emits ultra violet radiation integrated or associated therewith to health and beauty containers.

It is a further object of the present invention to provide an integrated multipurpose hybrid device which emits ultra violet radiation that gives added value to health and beauty containers.

It is a further object of the present invention to provide a new health and beauty instrument, a portable hybrid UV dryer for usage after coating fingernails in nail polish.

It is a further object of the present invention to provide a new nail file that built in on the portable hybrid UV finger nail dryer. Further objects of the present invention will become apparent in conjunction with the disclosure herein.

In accordance with the present invention, a series of novel portable multipurpose hybrid devices which emits ultra violet radiation for health and beauty aid and/or health and disinfections and/or attract fishes and/or insects and/or as work tool, are provided herein having unique design that turns it suitable to be changeable and versatility designation when assemble different apparatuses on the portable multipurpose hybrid UV device. A variety of different devices are disclosed, including, but not limited to, UV nail polish dryer device, UV nail polish with fan and/or blower dryer devices, UV nail polish with or without fan and/or blower dryer devices including built in and/or integrated finger nail file, and so forth. The devices can be integrated into the cosmetics container or attached thereto, whether to the exterior portion of the container, and/or to the container walls themselves.

In a preferred embodiment, the present invention fulfills the above and other objects that turns the ultra violet device suitable to be used as cap/cork/cover for cosmetics and health containers by replacing the original cap, in addition to its designation as UV fingernail dryer and nail file at the same time, by screwing it to the screw thread neck of the cosmetic bottle, as a novel alternative cap with added value that the original replaced cap didn't provide. The portable multipurpose hybrid UV device performs as a platform for different usages, which become possible with the assistance of the hole with the internal screw-on threads that designs to hold cosmetics apparatus and/or different designation accessories that changes the UV device designation. This hole gives to the UV device its versatility and multipurpose. In a preferred embodiment, the portable multipurpose hybrid device which emits ultra violet radiation includes a touch activated disposed in the device. The portable UV device preferably includes an ultra violet light source, an electric power supply, electrically connected to the ultra violet light source, and a touch switch connected to the ultra violet light source and the power supply. When the touch switch is depressed, the ultra violet light source is activated.

### BRIEF DESCRIPTION OF THE DRAWINGS

Parts numbers & figs interpretation:

1—A touch switch as disclosed at claim 6.

2—Metal housing and/or coloring polymer housing for the operating system as disclosed at claim 1, with an internal screw-on threads in order to screw it on part 6.

3—Electronics circuit board as disclosed at claim 1.

4—A button battery power source as disclosed at claim 2.

5—LED which emits ultra violet radiation as disclosed at claim 7.

6—Cylindrical acrylic and/or polycarbonate or the like resin and/or any other polymer as disclosed at claim 8.

7—External screw-on threads in order to screw the metal and/or polymer housing (part 2) to the extended cylindrical shape acrylic.

8—Nail file texture as disclosed at claim 9.

9—A hole as disclosed at claims 1; 10.

10—Internal screw-on threads in order to screw the UV device to the nail polish screw thread bottle neck and/or to any other designation accessories that changes the U device designation as disclosed at claims 1; 11; 13; 14; 15; 16; 17; 18; 19; 20.

11—Brush as the same pattern of fingernail polish brush, as disclosed at claim 14.

12—A water container as disclosed at claim 16.

13—Inner extruded mount with a screw as disclosed at claim 16.

FIG. 1 is a dissembled plan view of a portable multipurpose hybrid UV device as a first embodiment of the invention.

FIG. 2 is an assembled plan view of a portable multipurpose hybrid UV device as a first embodiment of the invention.

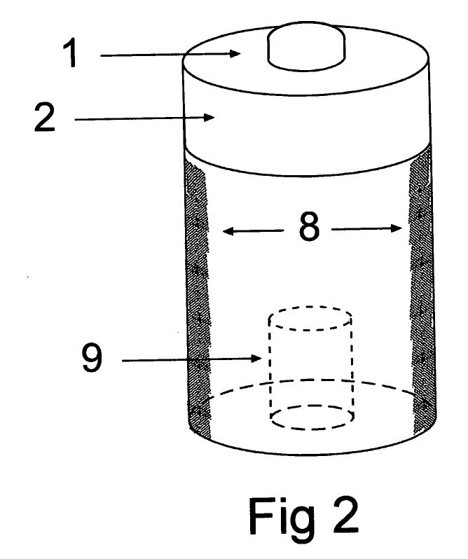

FIG. 3 is a cut off to half side view of the acrylic cylinder of FIG. 1 and FIG. 2.

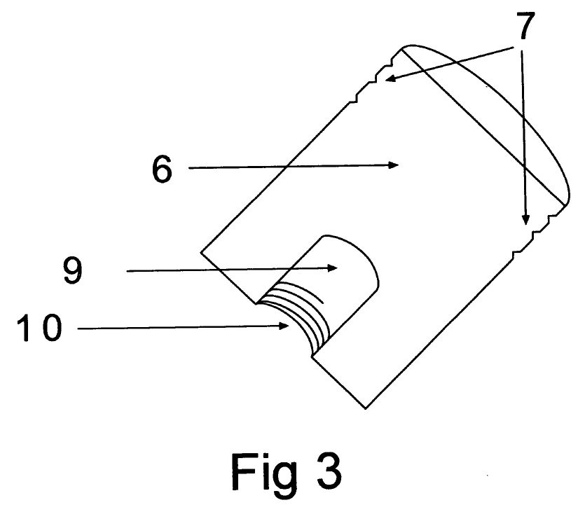

FIG. 4 is a plan view of a portable multipurpose hybrid UV device with assembled extruded brush as the same pattern of fingernail polish brush as a first embodiment of the invention.

FIG. 5 is a view of a fishing hook; it is one apparatus from several designation accessories that changes the UV device designation in order to attract fishes by assembling it on the fishing rod as disclosed at claim 17.

FIG. 6 is a view of a mount with a loop; it is one apparatus from several designation accessories that changes the UV device designation in order to attach the UV device to a rope in order to hang it on the neck like a medallion as disclosed at claim 20.

FIG. 7 is a view of a powder brush or make-up brush; it is one apparatus from several designation accessories as disclosed at claim 14. The UV device will perform as a handle grip for the powder brush or make-up brush.

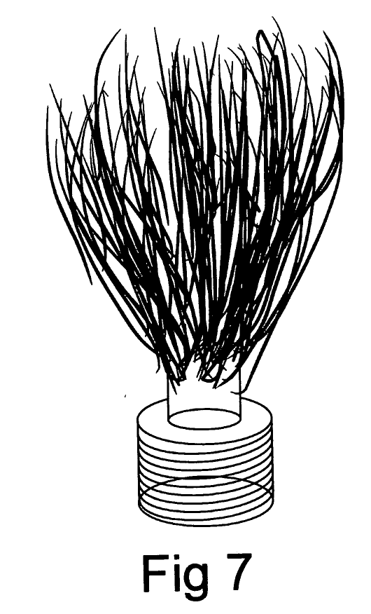

FIG. 8 is a view of an extruded spoon as the pattern of extruded tea spoon, it is one apparatus from several designation accessories that changes the UV device designation in order to turn it to disinfecting drinking water while stirring the water as disclosed at claim 16.

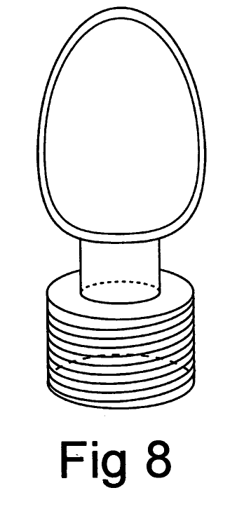

FIG. 9 is a view of a replaceable air freshener container as the pattern of air freshener. container for car; it is one apparatus from several designation accessories that changes the UV device designation in order to turn it to air disinfecting and purifications as disclosed at claim 18.

FIG. 10 is a view of a water container with an inner extruded mount on the cap/cork/cover in a way that the disinfecting UV device will be in the container dips in the water. This is one apparatus from several designation accessories that changes the UV device designation in order to turn it to disinfecting drinking water as disclosed at claim 16.

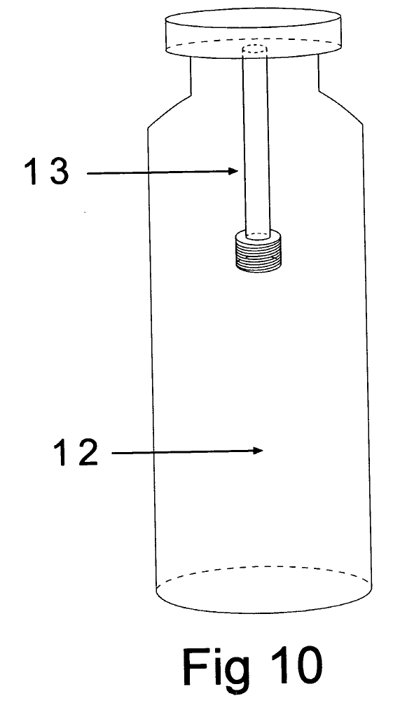

FIG. 11 is a view of a transparent container with an inner mount that contain glue on his side walls in order to catch insects. This is one apparatus from several designation accessories that changes the UV device designation in order to turn it to an insects exterminate as disclosed at claim 19.

FIG. 12 is a view of a hollow mount that connects to the tap and during the water will float through the mount the UV device will disinfect the tap water. This is one apparatus from several designation accessories that changes the UV device designation in order to turn it to disinfecting drinking tap water as disclosed at claim 16.

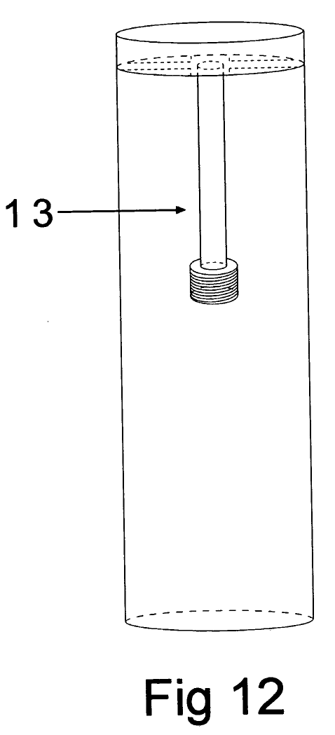

### DETAILED DESCRIPTION OF THE INVENTION AND THE PREFERRED EMBODIMENTS

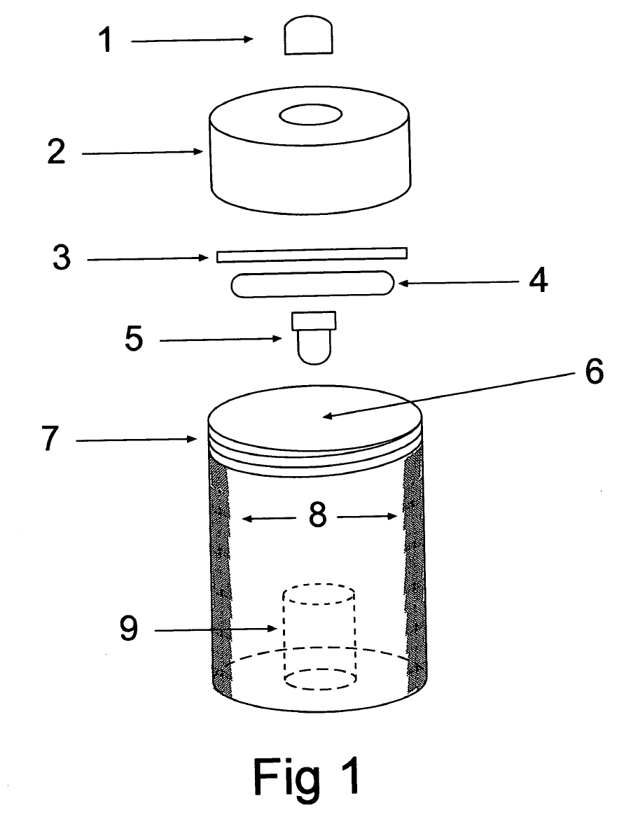

As shown in FIG. 1, in a first embodiment of the invention, one or more UV LED light which market as part 5 is incorporated into the operating system as disclosed at claims 1; 7. A touch switch as disclosed at claim 6, which market as part 1, will activate the light or lights 5. Instead of a touch switch which market as part 1, it can be a rotating member (not shown), and/or as disclosed at claim 6 and/or any other of the numerous types of switches known in the art. In the embodiment shown, the light is manually turned on by the user when the user desires, as, for example, by application of pressure to mechanism which market as part 1. In an alternative embodiment, the light can be activated automatically as disclosed at claim 6, whenever the user opens the cosmetics container.

In one embodiment of the invention, switch or mechanism which market as part 1 closes a connection allowing current to flow from a battery which market as part 4 to complete a circuit illuminating the light. However, this method is not exclusive, and any method known in the art for activating a light can be utilized consistent with the present invention.

Battery or batteries which market as part 4 at FIG. 1 are also mounted on circuit board which market as part 3 and provide power for one or more UV LED light which market as part 5. The illumination can be constant or can be periodic to produce a flickering effect, and will emit one or more length of waves as disclosed at claims 1; 7.

The UV illumination will pass through an extended cylindrical acrylic as disclosed at claims 1; 8, and as shown at FIGS. 1; 2; 3; 4, which market as part 6, that perform as a guide for the beam of light and also as a divider in order to project the ultra violet radiation 360 degrees equally. This extended cylindrical acrylic figure can also be in any desired geometric shape.

There is a trend in the world that continuously grow to bind several appliances in a special method that creates single small multi tool that can be carry easily. Perfect example will be the multi tool “LEATHERMAN” brand, that his inventor binds several work tools such as pliers, cuter, knife, saw, file, yardstick, screwdriver, scissors, bottle opener, and so forth, which binds in a smart and compact package that exempts the user from the need to carry many of heavy work tools that their natural place is the tool box at the storeroom, but allows the user to carry a large variety of small work tools to use when ever necessity. A proof to the genius of the “LEATHERMAN” brand is the large replications of different manufacturers all over the world. Bind several appliances in order to transfer them friendly to carry and use, is the purpose that stands behind the invention.

There are many manufacturers which manufacture UV nail dryers as well as nail files made from metal, glass, cardboard or acrylic, which indicate on a big demand for these products. The present invention binds those products into single small multi tool which can be screw to the nail polish bottle neck, that way it will be available to the consumers at all times, when ever needed.

The present invention is a portable UV device which designed to implement three actions as a stand alone device before assembling several designation accessories that changes the UV device designation: 1. To be use as UV fingernail dryer. 2. To be use as nail file with the assistance of the nail file texture along the acrylic cylinder. 3. To perform as a cap by replacing the conventional cap/cork/cover of the fingernail polish bottle, by its unique figure as disclosed at claims 1; 10, that allows to screwing it on the screw thread neck of the nail polish bottle, with or without extruded fingernail polish brush that reinforce inside of it, in order to seal the nail polish bottle, and simultaneously becoming an integral part from the nail polish bottle. More specifically, the present invention binds three devices that creates single small multi tool that exempts the user from the need to carry several cosmetics apparatus.

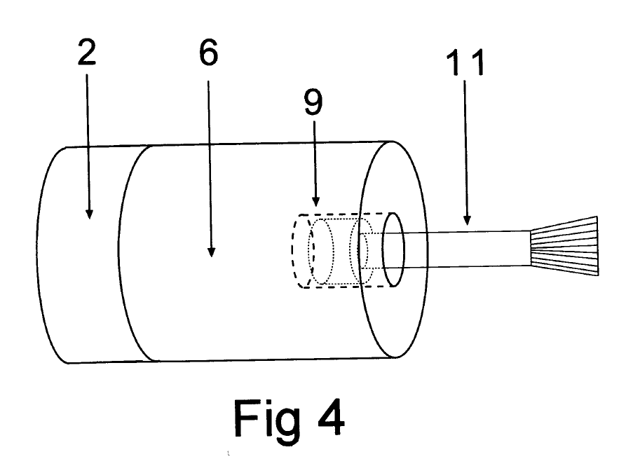

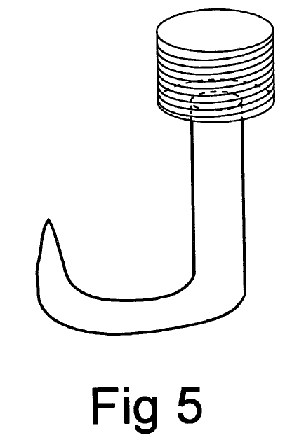

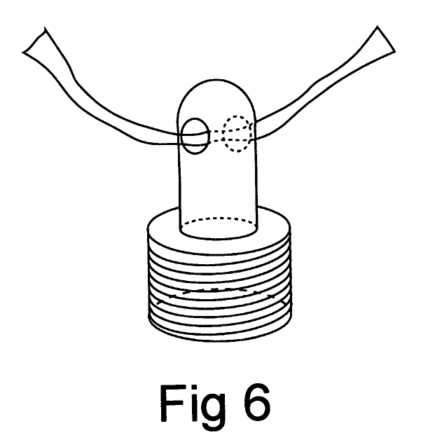

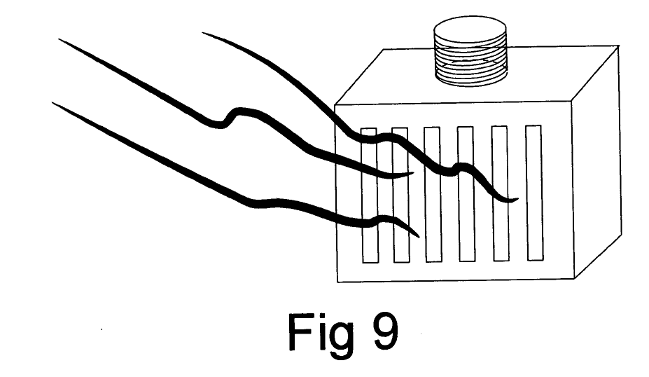

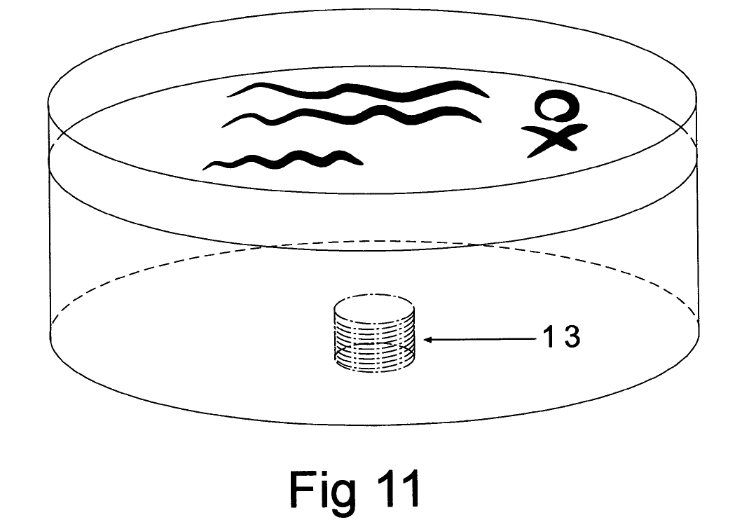

The portable hybrid UV device is multipurpose and is not limited to cosmetic use only. After assembling different designation accessories such as disinfecting pure drinking water as disclosed at claim 16 and/or to perform as air disinfecting and purifications as disclosed at claim 18 by assembling an air freshener container as shown at FIG. 9 and/or to attract fishes by assembling fishing hook as shown at FIG. 5 as disclosed at claim 17 and/or as UV decorative illumination as disclosed at claim 20 by assembling a mount with a loop in order to hang it on the neck as shown at FIG. 6 and/or to attract and kill insects as disclosed at claim 19 as shown at FIG. 11. The designation accessories give the stand alone UV device its versatility and its multipurpose different usage. The user can assemble the portable hybrid UV device with an extruded brush as the pattern of fingernail polish brush as part 11 at FIG. 4 as disclosed at claim 14, by screwing it on every common screw thread neck of nail polish bottles known in the art as disclosed at claim 13, in order to perform as cap/cork/cover for fingernails polish containers by replacing the original cap, as disclosed at claim 11. Thus, the user can maintain her nail polish bottle, the UV nail dryer and the nail file as disclosed at claim 9, as shown at FIGS. 1; 2, which market as part 8 integrated together into the same container, like the multi tool “LEATHERMAN” brand that binds several work tools. In this manner, the user always has the nail polish, the UV nail dryer and the nail file kept together on hand, like a portable beauty saloon, and does not need to separately search for both types of cosmetics apparatus when the user wants to apply them. Also it exempts the user from the need to carry many cosmetics apparatus in the bag. Despite the UV device perform as a cosmetic apparatus at this embodiment; the user can use the UV device to verify counterfeit paper money testing when ever the user has the desire to check paper money, even when it integrated into the nail polish container.

The UV device performs as a platform for different usages. The versatility and the multipurpose of the portable UV device become possible by the assistance of the novel hole with the internal screw-on threads that design to hold cosmetics apparatus and/or different designation accessories therein. The novel hole as disclosed at claims 1; 10, and as shown at FIGS. 1; 2; 3; 4, which market as parts 9; 10, gives to the UV device its versatility and multipurpose quality.

Having described this invention with regard to specific embodiments, it is to be understood that the description is not meant as a limitation since further embodiments, modifications and variations may be apparent or may suggest themselves to those skilled in the art. It is intended that the present UV application and the versatilities of the portable UV device covers all such embodiments, modifications and variations. The scope of the invention is defined by the claims appended hereto. Therefore, the portable UV device will be suitable in different versions to every men and women in the society.

What is claimed is:

1. A method comprising the steps of: (a) providing a portable multipurpose hybrid device which emits ultra violet radiation to be use as UV fingernail dryer; (b) said portable multipurpose hybrid device which emits ultra violet radiation comprising a hole with internal screw-on threads in addition to recess holding cosmetics apparatus therein; (c) said portable multipurpose hybrid device which emits ultra violet radiation comprising a hole with internal screw-on threads in addition to recess at the bottom of the hole, which designed to absorb, comprise and reinforce the base of extruded brush as the pattern of fingernail polish brush designation to remove liquid material from a container in order to spread it on fingernail or any other object, and/or different designation accessories that changes the UV device designation from nail dryer to water disinfection for example, as disclosed at claims 30; 31. It will be possible to install the different designation accessories by screw and/or by pressure and force and/or by glue. (d) said portable multipurpose hybrid device which emits ultra violet radiation design at unique form suitable to perform as cap/cork/cover for cosmetics and health containers by screwing it on the screw thread neck of the bottle, in order to replace the regular cap, in addition to its designation as UV fingernail dryer; (e) said cosmetics being selected from the group consisting of: nail polish, nail file, mascara, eyeliner, lipstick, lipliner, and lipgloss; (f) said portable multipurpose device further comprising one or more light source wherein said a bulb and/or module and/or light emitting diodes (LEDs) and/or any other of the numerous types of light source known in the art which emits ultra violet radiation (flicker and/or not flicker UV light), and wherein said device which emits ultra violet radiation. UV has two levels of radiation, ionizing and non-ionizing, which are separated by the length of waves they emit. Non-ionizing radiation ranges from 40-400 nanometers and is the most common form of UV radiation being used in biomedical and microbiological research laboratories. The ranges of non-ionizing UV can be charted into three regions: UVA (black light) at 315-400 wavelength (nm), UVB (erythemal) at 280-315 wavelength (nm), UVC (germicidal) at 100-280 wavelength (nm); (g) Said portable multipurpose hybrid device which emits ultra violet radiation comprising a power source therein; (h) Said portable multipurpose hybrid device which emits ultra violet radiation comprising electronics circuit board therein; (i) Said portable multipurpose hybrid device which emits ultra violet radiation comprising an operating switch therein.

2. A method as claimed in claim 1, wherein said portable multipurpose hybrid device which emits ultra violet radiation further comprises a replaceable and/or non replaceable electric power supply, being electrically connected to the portable multipurpose hybrid device which emits ultra violet radiation.

3. A method as claimed in claim 1, wherein said portable multipurpose hybrid device which emits ultra violet radiation further comprises a electric power supply and built in electric socket, said electric power supply being electrically connected to said portable multipurpose hybrid device which emits ultra violet radiation, with option to operate and/or recharge the electric power source by connecting the portable multipurpose device to the electric current network through built in electric socket.

4. A method as claimed in claims 1; 3 wherein said portable multipurpose hybrid device which emits ultra violet radiation further comprises a electric power supply and built in dynamo, with option to recharge the electric power source via the dynamo by rotating a handle and/or shaking and/or pulling a cord.

5. A method as claimed in claims 1; 3; 4, wherein said portable multipurpose hybrid device which emits ultra violet radiation further comprises an electric power supply and built in solar panels, said electric power supply being electrically connected to said portable multipurpose hybrid device which emits ultra violet radiation, with option to recharge the electric power source via the solar panels by putting the portable multipurpose device in the sunlight.

6. A method as claimed in claims 1; 2, wherein said portable multipurpose hybrid device which emits ultra violet radiation is activated by touch switch and/or by pulling a cord and/or by twisting a switch and/or by pulling the ultra violet bulb that functions as well as a switch and/or by unscrewing it from the container. When it will be close, the bottleneck will push on a micro switch that will stop the electrical circuit which connected to said electric power supply, wherein activates said portable multipurpose hybrid device which emits ultra violet radiation.

7. A method as claimed in claim 1, wherein said portable multipurpose hybrid device which emits ultra violet radiation further comprises at least one UV bulb and/or module and/or LED, which emits one or more length of waves, separately or together with the possibility to choose between them by switch. The illumination can be constant or can be periodic to produce a flickering effect.

8. A method as claimed in claim 1, wherein said portable multipurpose hybrid device which emits ultra violet radiation built from an extended cylindrical shape and/or any other shape, made from acrylic and/or polycarbonate or the like resin and/or any other polymer that will be transparent and/or translucent, and/or opaque and/or colored and/or coated with UV material and/or paint and/or phosphor glow-in-the-dark and/or can be designed to focus or refract the light by using reflective safety lighting material and/or all the above will integrated during the polymer blow molded process.

9. A method as claimed in claim 1, wherein said cosmetics therein comprises built in nail file, by implant metal file into the extended cylindrical polymer of the UV device and/or by gluing the file on the UV device and/or by making the nail file texture on the polymer surface during the polymer blowing/making process and/or after the process, and/or by gluing stripe of nail file to the UV device, and/or to create built in nail file on the UV hybrid device.

10. A method as claimed in claim 1, wherein said portable multipurpose hybrid device which emits ultra violet radiation comprises a hole with internal screw-on threads in addition to recess holding cosmetics apparatus therein; and wherein said portable multipurpose hybrid device which emits ultra violet radiation design at unique form suitable to perform as cap/cork/cover for cosmetics and health containers by screwing it on the screw thread neck of the bottle, in order to replace the regular cap, in addition to its designation as UV fingernail dryer. The internal screw-on threads can be made till the middle of the hole and/or till the bottom of the hole.

11. A method as claimed in claim 1, wherein said portable multipurpose hybrid device which emits ultra violet radiation design at unique form that turns it suitable to be use as cap/cork/cover for cosmetics and health containers, in addition to its designation as UV fingernail dryer, by screwing it on the screw thread bottle neck in order to replacing the original cap and/or by assembling it on the original cap in order to grasp on by friction and/or by assembling it on the original cap with a mount and/or connector.

12. A method as claimed in claim 1, wherein said portable multipurpose hybrid device which emits ultra violet radiation design at unique form will be assembling on the cosmetics and health containers in order to wraps the container like a package.

13. A method as claimed in claim 1, wherein a said cosmetic therein comprises cosmetics and health containers being selected from the group consisting of: nail polish, mascara, eyeliner, lipstick, lipliner, and lipgloss.

14. A method as claimed in claims 1; 13, wherein said cosmetics therein comprises an extruded brush as the pattern of extruded fingernail polish brush designation to remove liquid material from a container in order to spread it on fingernail and/or powder or make-up brush and/or any other object.

15. A method as claimed in claims 1; 13; 14, wherein said cosmetics therein comprises an extruded nail file as the pattern of extruded fingernail polish brush designation to polish and smooth the fingernail that will connect by screwing the file into the hole of the UV hybrid device.

16. A method as claimed in claim 1, wherein said waterproof portable multipurpose hybrid UV device perform as disinfecting pure drinking water, by killing germs and bacterium. The waterproof portable multipurpose hybrid UV device will be screw to the inner side of water container cap/cork/cover in a way that the disinfecting UV device will dips in the water and/or by install a replaceable extruded tea spoon reinforce into the recess at the bottom of the hole, and while stirring it will the disinfecting the water and/or by install it inside a hollow mount that connects to the tap and during the water will float through the mount the UV device will disinfect the tap water.

17. A method as claimed in claim 1, wherein said waterproof portable multipurpose hybrid device which emits ultra violet radiation comprises a hole in addition to recess holding accessory therein; and wherein said portable multipurpose hybrid UV device design at unique form suitable to perform as attracting fishes (by flicker and/or not flicker UV light) device by installing fishing hook by screwing it to the hole and the UV device will transfer immediately to attracting fishes device with an option to connect it to fishing rod.

18. A method as claimed in claim 1, wherein said portable multipurpose hybrid device which emits ultra violet radiation comprises a hole in addition to recess holding accessory therein; and wherein said portable multipurpose hybrid UV device design at unique form suitable to perform as air disinfecting and purifications by breaking up the NOx gas and/or by killing germs and bacterium. A replaceable air freshener container as the pattern of air freshener container for car will reinforce into the recess at the bottom of the hole, and the device will be turn to air disinfecting and purifications device, and simultaneously it will spread good odor.

19. A method as claimed in claim 1, wherein said screwing the portable multipurpose hybrid device which emits ultra violet radiation in order to attract insects, to an electrical iron net connected to outsource power in order to kill insects and/or to screw the UV device to the bottom of transparent container that contain glue on his side walls in order to catch insects, and/or to screw the UV device to the bottom of transparent container that contain poison that will kill the insects that attracts to the UV light.

20. A method as claimed in claim 1, wherein said portable multipurpose hybrid device which emits ultra violet radiation further comprises a mount with a loop in order to attach the UV device to a rope in order to hang it on the neck like a medallion as UV decorative illumination that creates nice atmosphere at discotheques and clubs.
